(19) United States
(12) Patent Application Publication
(10) Pub. No.: US 2014/0193540 A1
(43) Pub. Date: Jul. 10, 2014

(54) SOY/MILK CHEESE-TYPE AND YOGHURT-TYPE PRODUCTS AND METHOD OF MAKING

(71) Applicants: Chunguo Lin, Guelph (CA); Jin Chen, Guelf (CA); Milena Corredig, Guelf (CA); Art Hill, Fergus (CA)

(72) Inventors: Chunguo Lin, Guelph (CA); Jin Chen, Guelf (CA); Milena Corredig, Guelf (CA); Art Hill, Fergus (CA)

(73) Assignee: UNIVERSITY OF GUELPH, GUELPH, ONTARIO (CA)

(21) Appl. No.: 14/117,284

(22) PCT Filed: May 12, 2012
(86) PCT No.: PCT/CA2012/000445

§ 371 Date: Feb. 20, 2014

Related U.S. Application Data
(60) Provisional application No. 61/485,318, filed on May 12, 2011.

(51) Int. Cl. A23C 19/055

(52) U.S. Cl. CPC A23C 19/055
USPC 426/39; 426/582; 426/583

(57) ABSTRACT

Novel soy/milk gels are provided useful for making cheese-type and yoghurt type products. Method for preparing such products are also disclosed herein. In particular, the invention relates to a soy/milk cheese-type product which is a blend of soy milk and milk and to a method for the preparation thereof. In further aspects, is a soy/milk yoghurt-type product and a method for the preparation thereof.

### FIELD OF THE INVENTION

The present invention relates to soy/milk gels useful for making soy/dairy products. In particular, the invention relates to a soy/milk cheese-type product which is a blend of soy milk and milk and also relates to a soy/milk yoghurt type product which is a blend of soy milk and milk, both such products made from a soy/milk gel. The invention also relates to methods for the preparation thereof.

### BACKGROUND OF THE INVENTION

Soy products are becoming increasingly accepted by consumers due to the health benefits associated with the consumption of soy protein. Soy ingredients are widely used in a number of food products as they have good processing functionality. The protein obtained from soybeans is easily digestible, and thus it is valuable as a substitute for animal protein. Soy products containing high proteins have been associated with cholesterol lowering abilities. Furthermore, soy contains isoflavones which have been shown to be beneficial in the prevention of osteoporosis and inhibition of spreading of various cancers. Soybeans incorporated into food products could substantially lower the cost, while delivering the benefit of increasing the nutritional value of the final food products.

In the past decades, many attempts have been made in the production of soy cheese using soy milk. Examples of apparatus and processes for the processing of soy and or the production of soy milk may be found in U.S. Pat. No. 5,183,681, U.S. Pat. No. 5,270,450, U.S. Pat. No. 4,906,482, U.S. Pat. No. 4,971,825, U.S. Pat. No. 4,971,810, U.S. Pat. No. 5,077,062 and U.S. Pat. No. 5,137,736 (the disclosures of which are incorporated herein by reference in their entirety). Examples of soy cheese processes are found in U.S. Pat. No. 6,495,187, U.S. Pat. No. 6,455,081, U.S. Pat. No. 6,413,569, U.S. Pat. No. 6,399,135, U.S. Pat. No. 6,383,531 and U.S. Pat. No. 6,254,900 (the disclosures of which are incorporated herein by reference in their entirety). However, in most cases the soy cheeses are not commercialized to any extent because it is difficult to obtain a soy cheese with body and texture comparable to that of natural cheese. There are large differences in the structure and processing functionality between soy proteins and milk proteins, and therefore it is not possible to obtain similar textures with matrices composed with soy protein. In addition other functions of the cheese, for example, crumbliness, color or meltability are also not matched with tofu like products.

It is therefore desirable to develop a soy milk cheese product that overcomes at least some of the deficiencies of the prior art soy cheeses.

### SUMMARY OF THE INVENTION

Novel soy/milk gels are provided that are used to make soy/milk cheese type products. The gels are also suitable for use to make soy/milk yoghurt type products.

The present invention in an aspect provides a novel soy milk and milk cheese-type product (herein referred to as “soy/milk cheese-type product”). The soy milk and milk cheese-type product is a combination of soy milk and milk that has been simultaneously gelled (co-gelled). The soy milk and milk cheese-type product is a soy/milk curd that can be used for a variety of soft ripened cheese products, having good texture and body characteristics. The soy/milk cheese-type product has a favorable texture that is comparable to commercial regular cheese products, and has a synergy of health benefits associated with the presence of milk proteins, soy proteins and isoflavones.

The invention in further aspects provides a novel soy milk and milk yoghurt type product (herein referred to as “soy/milk yoghurt-type product”). The soy milk and milk yoghurt-type product is a combination of soy milk and milk that has been simultaneously gelled (co-gelled) and then syneresis (water released from the gel) is minimized such that the soy/milk gel retains a high water holding capacity to have a consistency of a yoghurt.

The invention also encompasses a novel method for making the soy/milk cheese-type product and the soy/milk yoghurt-type product of the present invention whereby acidification of soy protein and renneting of casein occurs simultaneously. These two gel forming processes as combined and occurring essentially simultaneously lead to the formation of a soy/milk gels used and then treated to make either a cheese-type product (soy/milk curd) with desirable properties or a yoghurt-type product with desirable properties.

According to an aspect of the present invention is a soy/milk cheese-type product.

According to another aspect of the present invention is a soy/milk cheese-type product having desired hardness, springiness, cohesiveness and chewiness similar to a milk-only soft cheese.

According to an aspect of the present invention is a soy/milk curd.

According to an aspect of the present invention is a soy/milk yoghurt-type product. Said soy/milk yoghurt-type product being similar in characteristics to dairy type yoghurts.

According to another aspect of the present invention is a soy/milk yoghurt-type product having desirable hardness and water holding capacity similar to a milk only yoghurt.

According to an aspect of the present invention is a soy/milk gelled slurry (gel).

In aspects of the invention, the novel soy/milk gelled slurry (gel) can be treated to provide a cheese-type or a yoghurt-type product.

According to yet another aspect of the present invention is a soy/milk cheese-type product comprising mixed gels of rennet coagulated casein micelles and acid coagulated soy protein.

According to still another aspect of the present invention is a soy/milk cheese-type product comprising gel structures of strands of interacting soy protein and milk protein.

According to yet another aspect of the present invention is a soy/milk yoghurt-type product comprising mixed gels of rennet coagulated casein micelles and acid coagulated soy protein.

According to still another aspect of the present invention is a soy/milk yoghurt-type product comprising gel structures of strands of interacting soy protein and milk protein.

According to another aspect of the present invention is a method for making a soy/milk cheese-type product, the method comprising:

(a) mixing heated soy milk with cold renneted milk;

(b) cooling and acidifying to cause simultaneous gelation of (a);

(c) coagulating cooled (b) and setting;

(d) incubating (c) overnight; and

(e) dry salting (d) to form said cheese-type product.

Alternatively, direct acidification of the hot soya milk may be effected. In this case. citric acid, lactic acid or glucono-delta-lactone (GdL) is added to the warm soy milk/milk mixture first.

In aspects, the method further comprises allowing the dry salted cheese-type product to dry refrigerated and then immersing in a brine solution.

According to another aspect of the invention is a method for making a soy/milk cheese-type product, the method comprising:

(a) mixing heated soy milk with cold renneted milk;

(b) acidifying and cooling (a) to effect simultaneous gelation of the soy milk and the milk;

(c) coagulating cooled (b) and setting;

(d) allowing (c) to incubate overnight; and

(e) dry salting (d) to form said cheese-type product.

In aspects of the method, the acidifying comprises adding lactic acid, citric acid, or GdL to (a). In further aspects, the acidifying comprises adding lactic acid-producing bacteria to the cold renneted milk prior to mixing with the heated soy milk.

According to another aspect of the present invention is a soy milk and milk cheese-type product made by a method comprising:

(a) mixing heated soy milk with cold renneted milk that comprises an acidifying agent;

(b) cooling to effect gelation of (a);

(c) coagulating cooled (b) and setting;

(d) allowing (c) to incubate overnight; and

(e) dry salting (d) to form said cheese-type product.

According to another aspect of the invention is a soy/milk cheese-type product prepared by a method comprising:

(a) mixing hot soy milk with cold renneted milk;

(b) acidifying and adding a firming agent to said mixture from (a);

(c) mixing the product resulting from (b) for a time sufficient to cool (b) and effect simultaneous gelation of soy milk and milk;

(d) transfer the product resulting from (c) into molds at a temperature of less than about 35° C.; and

(e) optionally salting (d).

In aspects, the acidifying agent is a lactic bacterial culture. As the cold renneted milk heats when mixed with the hot soy milk, culturing of the milk takes place as the bacteria then grow and multiply and the soy milk gels simultaneously with the renneted milk.

According to another aspect of the present invention is a method for making a soy milk and milk cheese-type product, the method comprising;
adding lactic culture to renneted milk and storing refrigerated overnight without coagulation;
adding hot soy milk at about 80-85° C. and mixing during which time the temperature of the mixture cools to about 38-40° C.;
slowly adding a gelation agent and stirring to allow the mixture to coagulate and form a curd;
incubating the curd overnight and salting; and
optionally immersing the salted curd in a brine solution.

In aspects of the method, when a soy/milk gel is formed, the soy/milk gel can be treated such that the extent of syneresis is minimized so that there is a high water holding capacity. In this manner, the soy/milk gel with a high water holding capacity has a texture more in keeping with a milk yoghurt product.

According to a further aspect of the invention is a soy/dairy yoghurt-type product comprising mixed gels of rennet coagulated casein micelles and acid coagulated soy protein.

According to another aspect of the invention is a method for making a soy/milk gel, the method comprising:

(a) mixing heated soy milk with cold renneted milk;

(b) acidifying and cooling (a) to effect simultaneous gelation of the soy milk and the milk; and

(c) optionally fermenting (b).

In further aspects, the method further comprises the step of decreasing syneresis to increase water holding capacity of said gel. The invention encompasses a soy/milk yoghurt product made such method.

According to yet a further aspect of the invention is a soy/milk cheese-type product or a soy/milk yoghurt-type product, said products comprising mixed gels of rennet coagulated casein micelles and acid coagulated soy protein.

Other features and advantages of the present invention will become apparent from the following detailed description. It should be understood, however, that the detailed description and the specific examples while indicating embodiments of the invention are given by way of illustration only, since various changes and modifications within the spirit and scope of the invention will become apparent to those skilled in the art from said detailed description.

### BRIEF DESCRIPTION OF THE DRAWINGS

The present invention will become more fully understood from the detailed description given herein and from the accompanying drawings, which are given by way of illustration only and do not limit the intended scope of the invention.

FIG. 1 shows the particle size distribution of soy milk (SM), skim milk (SMP) and a 50:50 mixture of SM and SMP determined by light scattering;

FIG. 2 shows acidification as a function of time for gels made with T1, T2, T5, T6, and the mixes of SM/SMP (50/50) with rennet or GDL without CaCl2. Treatment codes are defined in Table 1;

FIG. 3 shows averaged storage modulus (G′) as a function of pH for gels made with T1, T3, T5, T6, and the mixes of SM/SMP (50/50) with rennet or GDL without CaCl₂. Treatment codes are defined in Table 1;

FIG. 4 shows the average measurement of storage modulus (G′) as a function of time for gels made with T1, T2, T5, T6 and the mixes of SM/SMP (50/50) with rennet and CaCl₂. Treatment codes are defined in Table 1;

FIG. 5 shows confocal scanning micrographs of soy, milk and mixed soy/milk gels. T1 SMP, 2% protein, rennet; T2 SM, 2% protein, GDL; T3 SMP, 4% protein, GDL; T4 SM, 4% protein, GDL; T5, 50:50 SM:SMP, 4% protein, GDL, rennet; T6 50:50 SM:SMP, 4% protein, GDL. Bars represent 6 μM;

FIG. 6 shows syneresis of soy, milk and mixed soy/milk gels. Treatment codes are defined in Table 1;

FIG. 7 shows the textural properties of the soy/milk cheese-type product of the invention;

FIG. 8 shows SEM imaging of the soy/milk cheese-type product of the invention; and

FIGS. 9A-9B show various process steps in the making of the soy/milk cheese-type product. FIG. 9A shows mixture of co-gelled soy and milk; FIG. 9B shows the curd appearing separated from the whey after 30 minutes; FIG. 9C shows curd poured into molds; FIG. 9D shows curd incubated overnight at 30° C. under gravity; FIG. 9E shows soy/milk cheese-type product sample; FIG. 9F shows the soy/milk cheese-type product salted; FIG. 9G shows the salted product brined; and FIG. 9H shows the soy/milk cheese-type product after two weeks.

### DETAILED DESCRIPTION OF THE INVENTION

Broadly stated, the invention is a novel soy/milk gel that can be further treated to provide novel and desirable soy/milk cheese-type products and novel and desirable soy/milk yoghurt-type products.

The present invention in an embodiment provides a novel and desirable soy/milk cheese-type product that is similar to conventional milk based soft ripened natural cheeses with respect to taste and physical characteristics and yet provides additional health benefits such as reduced cholesterol and containing beneficial isoflavones. The soy/milk cheese-like product is a curd that can be used as a basis for a variety of soft ripen cheese products. It is believed to be useful for the manufacture of cheeses that are designated as “Soft” according to the CODEX General Standard for Cheese (A6) Firmness Designators. These include, for example but are not limited to, feta, cream cheese, fresh fermented cheeses, and surface ripened varieties such as brie and camembert.

The invention also encompasses a novel method for making a soy/milk cheese-type product having similar physical characteristics to natural milk cheeses, but with novel taste profiles and a different protein composition. The novel method is based on creation of an interacting gel by virtue of having two gel forming processes (acidification of soy protein and renneting of casein) occurring simultaneously. This results in a novel soy/milk cheese-type product having rheological properties and desired gel microstructure and therefore being in the same product category as conventional type cheeses.

Generally, the method comprises forming a gel from mixtures of heated soy milk (SM) and cold reconstituted skimmed milk (SMP). This is accomplished by adding heated soy milk to cold renneted milk and acidifying. In one aspect of the method, hot soy milk is added to cold renneted milk to which an acidifying agent is added (renneted/acidified milk). Gelling via acidification will not take place until mixing with the hot soy milk. The cold renneted/acidified milk does not gel until the hot soy milk is added thereto. In another aspect of the method, the acidification is done by adding an acidifying agent to the mixture of the hot milk and cold renneted milk. Still in another aspect, the acidification can occur by directly acidifying the hot soy milk via acid fermentation, by addition of calcium and/or magnesium, or by addition of citric, lactic acid or GdL.

Acidification with the use of lactic culture to the cold renneted milk as the acidifying agent occurs as the temperature of the mixture warms as the lactic culture will grow in warmer temperatures only, reaches to about 40° C. or less. Mixing the hot soy milk with cold renneted/acidified (i.e. cultured) milk brings the mixture to a temperature that affects the gelation process of both the soy milk and the renneted acidified milk, causing both to occur simultaneously and to interact to form a mixed gelled network of the two proteins, and a gelled slurry. Culture then occurs with the warmer temperature of the gel. To aid in the gelation of the soy protein or the milk protein a firming agent can be utilized while stirring is maintained. This gelled slurry is then allowed to set to form a curd which is poured without breaking into a cheese mold and incubated overnight at suitable temperatures, depending on the starter culture used. The curd may then be pressed and/or dry salted by rubbing all sides of the curd surface with dry salt, to allow for some syneresis to occur while refrigerated. The curd is turned a few times. After a couple of days the salted curd may be immersed in a brine comprising salt and stored at suitable cool temperatures of about 4° C.

It is believed that gelation of both principal soy globulins, β-conglycinin and glycinin is induced by the addition of the cool renneted/cultured milk (but not yet coagulated) to the hot soy milk. During cooling, soy proteins rearrange mainly through non-covalent interactions, causing stiffening of the gel network. Gelation of heated soy milk can be effected by quiescent acidification via acid fermentation or addition of glucono-delta-lactone which slowly converts to gluconic acid when dissolved in an aqueous medium, or by addition of ions such as magnesium or calcium. The gelation of soy proteins occurs because of charge neutralization, and bridging by cations present in the serum phase. During acidification from neutral pH, coagulation begins at about pH 6.2. The principal milk proteins, caseins, can be coagulated by acidification to pH less than about 5.0 or at higher pH values (lower acidity) via enzymatic coagulation, namely, renneting. Soy-dairy mixed gels with differing functionalities can be created by combining coagulation (i.e. gelation) of soy proteins in the pH range of about 5.2-6.4 and rennet coagulation of caseins. These gelation processes are made to occur simultaneously in the mixed gels and without being bound to theory, three gel structures are possible: (1) a gel structure formed predominately of soy proteins with coagulated caseins as inert (not interacting with the soy protein) particles within the soy gel matrix; (2) a gel structure formed predominately of renneted caseins with particles of acid coagulated soy proteins as inert particles within the milk gel matrix; or (3) a gel structure formed with interacting soy and dairy proteins.

In further embodiments of the invention, the soy/milk gel made from mixtures of heated soy milk (SM) and cold reconstituted skimmed milk (SMP) can be processed in a manner to provide a yoghurt-type product. In this aspect (see example one for a non-limiting example) the gel is not subjected to syneresis or minimally subjected to syneresis such that a high water holding capacity is provided. In this manner, novel soy dairy products can be made that are comparable to milk yoghurt products in texture, and yet have the benefits of soy.

The soy milk can be purchased or made from dry soybeans. The soy milk is typically filtered to eliminate fiber material. A soy protein extract as a base for the process may also be made from mixing soy flour (dehulled soy flour or defatted soy flour), soy powder, soybean flakes, soy concentrate, and/or soy protein isolate with water. In general, any source of soy protein can be used in the present invention as would be understood by one of skill in the art. The soy milk may have a concentration of up to about 10% protein and in aspects about 3-6% protein. If soybeans are used as starting material, then the soy milk should be heated to a high enough temperature and for a sufficient time to denature any anti-nutritional compounds (such as trypsin inhibitors). If soy protein suspensions are to be prepared, then heating is desired to solubilise the proteins from the powder. Suitable temperatures are about 60° C. to about 95° C. for up to about 10 minutes. One of skill in the art would recognize suitable temperatures and times. The heated soy milk is then prepared and ready to add to the milk.

The milk used in the present invention may comprise from about 0% to about 10% fat and in aspects from about 0.5% to about 5% fat. It may be desirable to use milk with a low fat content and optionally add fat from other sources. In the present invention skim milk is used in one aspect to reduce the fat content however, it is encompassed that higher fat milk including homogenized milk can be used as is desired and understood by one of skill in the art. It is expected that the addition of fat to the mixture may improve the appearance, texture and mouth feel of the cheese curd. Any type of milk that could be used in cheese making can be used as understood by one of skill in the art. The milk used may be from different sources such as for example pasteurized cow's milk, buffalo milk or goat's milk (including mixtures thereof) that is kept refrigerated at about 4° C.

The milk is prepared for adding to the hot soy milk. To cold milk diluted rennet (125 μl concentrated Chy-mx Extra rennet Milwaukee, Wis. U.S.A.) is added and then the mixture stored overnight for the rennet to go to completion. The amount of rennet for use is understood by one of skill in the art. In aspects, the concentration of rennet for use can be about 0.01-0.002 IMC/g. In aspects the amount of rennet for use may be about 0.020 IMC/g, sufficient for the renneting reaction to reach completion. Indirect acidification (i.e. culturing) of the cold renneted milk is performed microbially by the addition of a starter culture of one or more lactic acid-producing bacteria to the milk, and then allowing the bacteria to grow and multiply (culture) when the mixture is warmed by adding to the hot soy milk. Milk with lactic acid-producing bacteria added thereto is referred to as cultured milk herein. In one aspect of the present method a freeze-dried concentrated lactic cheese culture (Choozit Mass. 16 LYO, Danisco France) is used at a dosage of about 0.625 DCU (0.005%) bacteria per 10 kg/milk. One of skill in the art would recognize that a variety of bacteria can be added that impart a desired flavour and other desired character to the final product. For example, lactic acid cultures and suitable adjuncts such as probiotics and flavour enhancing cultures can be used. Probiotic cultures may be selected from the group consisting of Lactobacillus, Lactococcus, Streptococcus, Bifidobacterium and combinations thereof. Once renneted and cultured (i.e. acidified), the milk is kept cold until ready for mixing with the hot soy milk. At this point the renneted and cultured cold milk has not coagulated. Alternatively, direct acidification may be used instead of lactic acid bacteria. In this case. citric acid, lactic acid or glucono-delta-lactone (GdL), for example, is added to the warm soy milk/milk mixture.

To effect simultaneous gelation, the cold renneted milk is mixed with the hot soy milk causing the temperature of the soy milk to quickly decrease and the temperature of the milk to quickly increase to less than about 40° C. At this temperature, the lactic acid bacteria are able to grow and thus act to acidify the mixture. Alternatively, if lactic acid bacteria were not used, direct acidification may be done by adding citric acid, lactic acid, or GdL directly to the warm mixture.

To increase gelation of the soy protein, firming agents may optionally be added to firm the curd. Preferably, calcium chloride is added to help gel and form a curd and can be added in amounts of from about 0% to about 0.5%, in aspects from about 0% to about 0.2%. In aspects, MgCl₂ (0.25 g/ml) is slowly added while stirring the gelling (coagulating is synonymous) slurry. After stirring, the coagulated mixture is left undisturbed to set for a sufficient time to form a curd and incubated at a certain temperature for sufficient time to develop the required acidity. The quiescent time for curd formation can be up to 60 minutes or so as understood by one of skill in the art. The gelled curd is poured into a mold and incubated at about 30° C. or higher, overnight after which dry salting of the curd takes place. The temperature will be the optimal growth temperature for the starter culture employed. The dry salted curd can be partially dried for days and refrigerated. To maintain a soft ripened cheese-type product of soy and milk, the drying curd is not subject to pressure. To form a firmer cheese-type soy/milk product pressure can be applied to remove more moisture from the product as it dries. The salted cheese-type product is then optionally brined and stored.

The invention provides the above and below described methods wherein said soy protein is present in the final soy/milk cheese-type product in amounts of from about 10% to 60% by weight, and preferably from about 15% to about 50%. By “percent” it is meant weight percent based on the calculated amount of casein solids in the milk. Milk is present in amounts of from about 10% to about 90%.

Ingredients may be included in the slurry such as, but are not limited to, non-fat dry milk, a milk protein, an acidity regulator, an acid, an anticaking agent, an antifoaming agent, a coloring agent, an emulsifier, an enzyme preparation, a flavoring agent, a firming agent, a food protein, a gelling agent, a preservative, sequestrants, a stabilizer, a starch, a thickener, an oil, a fat, a cheese powder, a salt, a nutritional supplement, an acid, an enzyme, a neutraceutical, a carbohydrate, a vitamin, a mineral, soluble fiber sources. Examples may further include procream, whey cream, a dairy solid, and foodstuffs of vegetable, fruit and/or animal source. The foodstuffs may include fruit, vegetables, nuts, meat, and spices, among other foodstuffs.

Depending on the character desired in the end soy milk/milk cheese-type product, a sweetener or sweeteners may be added to the gelled curd (i.e. the slurry). Examples of suitable sweeteners include artificial and natural sweeteners such as saccharin, sucrose, fructose, glucose, corn syrup, maltose, honey, glycerin, fructose, aspartame, sucralose, high fructose corn syrup, crystallized fructose, acesulfame potassium, and mixtures thereof. The amount of sweetener used in the acidified compositions will vary depending on the desired taste and the perceived sweetness of the specific sweetener selected.

If desired, bulking agents may be added to the curd to enhance the textural properties. Suitable bulking agents include, but are not limited to, maltodextrin, corn syrup solids, dextrose, lactose, whey solids, and mixtures thereof.

Food starches can also be used in the manufacture of the soy milk/milk cheese-type product of the present invention to aid in water management. In general, starch can be incorporated into the final product in the range of about 0.5-4.0 wt. %.

Suitable starches include, for example, modified and unmodified food starches, corn starch (dent or waxy), rice starch, tapioca, wheat starch, flour, potato starch, native food starches having cross-linked polysaccharide backbones, and mixtures thereof.

A number of different types of generally recognized as safe (GRAS) ingredients can be incorporated into the slurry and optionally added at other stages of the overall manufacturing process as described herein. If added at a stage other than the slurry, most ingredients can generally be added as a powder, coating or as a dressing. The ingredients that are incorporated are selected, for example, to tailor the performance, nutritional, and taste characteristics of the final soft or firm/semi-hard cheese product. Different types of gums or stabilizers can also be incorporated into the cheese. The cellulose can be either natural or modified. One cellulose or combinations of different celluloses can be utilized. Types of celluloses that can be utilized include, but are not limited to, microcrystalline cellulose, powdered cellulose, methylcellulose, propylene glycol alginate, and sodium alginate. Examples of suitable gums that can be incorporated include, but are not limited to, xanthan gum, guar gum, konjac flour and locust bean gum. Examples of suitable stabilizers include chondrus extract (carrageenan), pectin, gelatin, and agar, or the soluble fraction of the soybean polysaccharides. The total amount of gums and stabilizers included in the final cheese product is typically up to about 0.01, about 0.50, or about 3.0% by weight. More specifically, the amount of gums and/or stabilizers can range from about 0.01 to 3.0%, from about 0.25 to 2.5%, from about 0.5 to 2.0%, or about 0.75-1.5% by weight of the final cheese-type product. Gums and stabilizers concentrations in the slurry are typically in the range of about 0.02-6.0, or 0.50-5.0 wt. %.

Any colorants known in the art, including all certified colorants and natural colorants may be used in the soy milk/milk cheese-type product to impart a cheese color to the compositions. If the end product desired is to be a yellow/orange imitation cheese composition, the preferred colorants are Certified Yellow #5, Certified Yellow #6, annatto, carotenels, or oleoresin paprika. Additionally, it may be desirable to include titanium dioxide in the composition, to increase overall opacity. If desired, preservatives may be included in the acidified food composition to prevent discoloration or decay, and to further ensure avoidance of microbial or fungal spoilage, or other degradation of the composition's components. Such preservatives include, for example, sodium benzoate, potassium sorbate, sorbic acid and EDTA.

In addition to cheese flavorings discussed above, additional flavorings or flavor-enhancing additives may be included in the soy milk/milk cheese-type product, as long as such additions do not substantially alter the character of the product. Such flavorings may include, for example, spices, such as black pepper, white pepper, salt, paprika, garlic powder, onion powder, oregano, thyme, chives, basil, curry, Worcestershire sauce, soy sauce, mustard flower, yeast extracts, cumin and mixtures thereof. Additionally, particulate components such as fruit or vegetable matter, meat, tofu, or nuts may be added. Flavoring agents are typically added in an amount such that the concentration in the final cheese product is within the range of about 0.01 to 5 wt. %. If incorporated into the slurry, the concentration of the flavoring agent in the slurry is generally is in the range of about 0.02 to 5 wt. %.

Salts of various types, but typically sodium chloride, can be added to tailor the flavor of the final cheese. The salt can be incorporated into the final cheese product by including it in the heated slurry or by adding it in granular form or as an unheated solution apart from the slurry. Regardless of how introduced, the salt concentration in the final cheese product is usually added at a level of about 0.1-5 wt. %. When added as an ingredient of the slurry, this means that the salt concentration in the slurry is generally about 0.0 to 25.0 wt. %, for example about 0.5-22%, or about 1-18% by wt.

Neutraceuticals may be included to deliver nutrients not normally present in cheese. Examples of neutraceuticals include, but are not limited to lycopene, antioxidants, probiotics, prebiotics, phosphatidylserine, vegetable sterols, immunoglobulins. These products in particular may be added as part of the slurry or to the final cheese-type product.

We note that the term “gel” and “slurry” are used interchangeably in this description.

Although preferred amounts of the various components of the soy milk/milk cheese-type product have been detailed herein, it will be apparent to one of skill in the art that the amounts of the components can be varied depending on the taste, texture, viscosity, color, and/or other organoleptic properties desired in the final soy/milk cheese-type product of the invention.

Similarly, the soy/milk yoghurt type product of the invention may be varied with respect to the amounts of the components depending on the desired taste, texture, viscosity, color, and/or other organoleptic properties desired in the final soy/milk yoghurt-type product of the invention. The soy/milk type product of the invention can also incorporate any or all of the other components as described herein for soy/milk cheese-type products such as one or more of nonfat dry milk, a milk protein, an acidity regulator, an acid, an anticaking agent, an antifoaming agent, a coloring agent, an emulsifier, an enzyme preparation, a flavoring agent, a firming agent, a food protein, a gelling agent, a preservative, sequestrants, a stabilizer, a starch, a thickener, an oil, a fat, flavour powders, a salt, a nutritional supplement, an acid, an enzyme, a neutraceutical, a carbohydrate, a vitamin, a mineral, soluble fiber, fruit, vegetables, nuts, meat, spices, and other foodstuffs.

The above disclosure generally describes the present invention. A more complete understanding can be obtained by reference to the following specific Examples. These Examples are described solely for purposes of illustration and are not intended to limit the scope of the invention. Changes in form and substitution of equivalents are contemplated as circumstances may suggest or render expedient. Although specific terms have been employed herein, such terms are intended in a descriptive sense and not for purposes of limitation.

### EXAMPLES

### Example One

### Production and Characterization of Soy/Milk Gels

Table 1 summarizes the various treatments used in the study. The protein content of the soymilk (SM) and milk (from reconstituted skim milk powder, SMP) mixes was kept constant at 4%, and controls containing only 2% of skim milk proteins or soymilk proteins were also used. The mixes were aggregated by a combination of rennet and acidification (using GDL). CaCl₂ was also added to all the samples.

TABLE 1

| | | | Distilled | | |
|---|---|---|---|---|---|
| | 4% SM | 4% SMP | Water | GDL | Rennet |
| Treatment | (ml) | (ml) | (mL) | (g) | (μl) |
| T1 | 0 | 12.5 | 12.5 | 0 | 200 |
| T2 | 12.5 | 0 | 12.5 | 0.25 | 0 |
| T3 | 0 | 25 | 0 | 0 | 200 |
| T4 | 25 | 0 | 0 | 0.25 | 0 |
| T5 | 12.5 | 12.5 | 0 | 0.25 | 200 |
| T6 | 12.5 | 12.5 | 0 | 0.25 | 0 |
| T7 | 17.5 | 7.5 | 0 | 0.25 | 200 |
| T8 | 22.5 | 2.5 | 0 | 0.25 | 200 |

Note:
4% SM is the soymilk(SM) containing 4% soy protein
4% SMP is the skim milk powder (SMP) solution containing 4% milk protein
GDL is Glucono delta-lactone at a concentration of 1.0% (w/v)
Rennet concentration was 0.001% (v/v).
All treatments included CaCl₂ at concentration in the final mix of 2 mM.

### Soymilk Preparation

Soymilk was prepared according to the procedure of Mullin et al. (2001) with slight modifications. Soybeans (Harovinton variety, grown at the Agriculture and Agri-Food Canada Harrow research station, Harrow ON) were weighed (100 g) and soaked in excess water overnight at room temperature, drained and rinsed with cold water and drained again, then reweighed to determine the amount of water absorbed by the beans. The water uptake was calculated by dividing the weight of the soaked beans by the initial weight of the dry beans. The amount of additional water needed to obtain a ratio of 18:1 water to protein was then calculated by subtracting the amount of absorbed water.

Approximately half of additional water needed was then added to the beans at 20° C. and blended (commercial blender, WARING, New Hartford, Conn.) at high speed for 3 min. The remaining water was heated to 60° C. and added to the slurry for better protein extraction, and the whole mixture was blended at high speed for another 30 s. A two-step filtration was then carried out to remove the coarse material (okara, which is mainly composed of fiber material). The slurry was filtered through a juice extractor (Juiceman, professional series 211, Korea) and the okara was collected and passed through the juice extractor again. The soymilk obtained from the juice extractor was filtered through cheese cloth to remove fines (Mullin et al., 2001). A portion of raw soymilk was then divided in test tubes (10 ml each tube) and heated in boiling water (90-100° C.) for 7 min, following a previously published procedure (Ono et al., 1991) and cooled to room temperature in an ice-water bath. The heated soymilk was then centrifuged at 10,000 g for 30 min at 20° C. in a refrigerated ultracentrifuge (Optima LE-80K Beckman Coulter, Calif., USA) to eliminate any additional large particles. The protein content of collected supernatants was measured using Dumas method (LECO, FP-528, Mississauga, ON, Canada) using EDTA as standard for calibration of the instrument. The protein concentration was calculated using 6.25 as a conversion factor.

Low heat skim milk powder, purchased from Dairy Farmers of America (Kansas City, Mo.), was used for the study. Skim milk powder was suspended (12% solid total solids w/v) in high-purity water containing 0.02% sodium azide (to avoid microbial growth), stirred for 2 h, and incubated overnight at 4° C. to ensure complete hydration.

Particle Size Analysis: Mastersizer 2000 (Malvern Instruments Ltd, UK) was used to determine the protein particle sizes of 2% soymilk, 2% skim milk powder solution and the mixes of 2% soymilk and 2% skim milk powder solution. The values of refractive index used were 1.39 for skim milk particles, 1.46 for soymilk and 1.42 for the mixes of soymilk and skim milk powder solution.

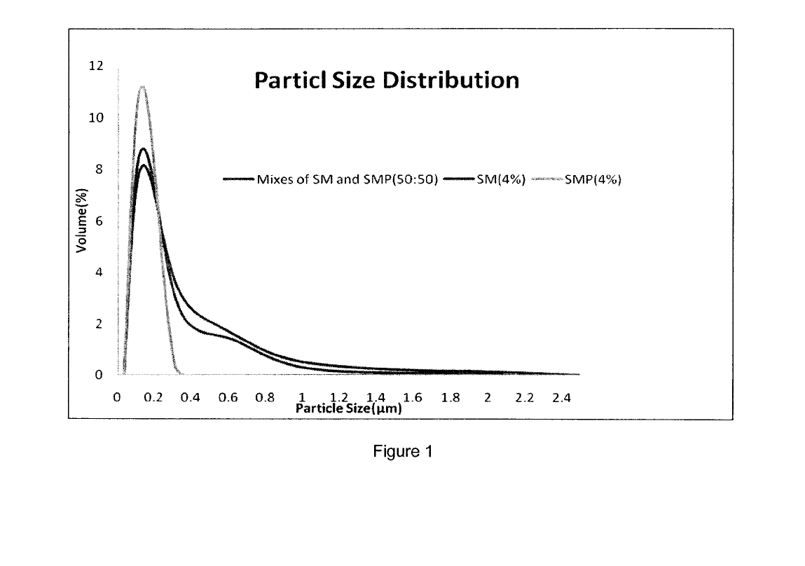

FIG. 1 illustrates the particle size distribution of various samples of soymilk (SM), reconstituted skim milk (SMP) and a 50:50 (v/v) mix. All samples showed a monomodal size distribution with most particles in the range between 0.05 μm and 0.3 μm. Soymilk showed a shoulder with particles of larger diameter and a similar particle size distribution was also noted for the 50:50 mixture.

Rheological Measurements: A controlled stress rheometer and Rheology Advanced Data Analysis software version 5.0.38, both from TA instruments Ltd., New Castle, Canada, were used to collect and analyze the experimental data. A conical concentric cylinder geometry (20 ml sample size, 5920 um fixed gap, 15 mm radius, 14 mm rotor outer radius and 42 mm cylinder immersed height) was used to measure time sweeps and frequency sweeps at a constant temperature of 30° C., controlled by a temperature-controlled water bath. A 20 mL sample was loaded into the rheometer.

A water trap was used to minimize evaporation during the measurement. Time sweep measurements were carried out with a constant maximum strain of 0.01% and a frequency of 0.1 Hz. After four hours, a frequency sweep test was performed applying a constant stress of I Pa in the frequency range from 10-0.005 Hz.

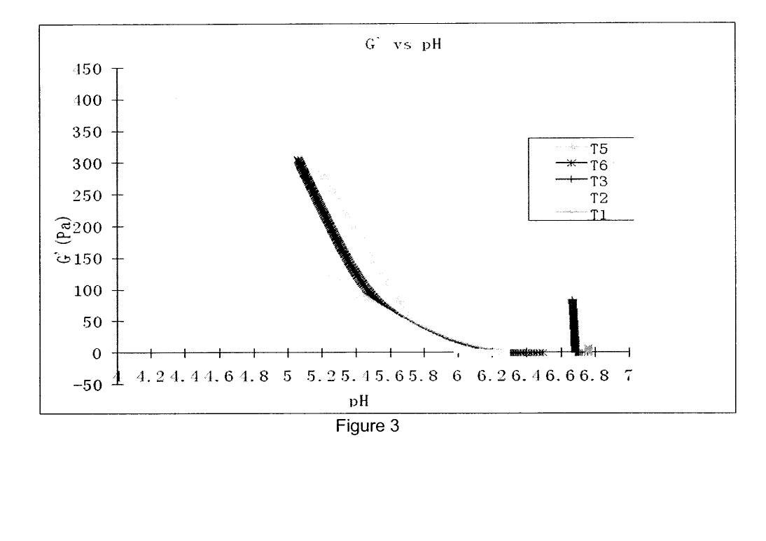

Dynamic rheological measurements provide information on the viscoelastic nature of food materials. Dynamic rheological tests can be used to study the characteristics of the gel as well as of gelation (solution-gel) and melting (gel-solution transition). From dynamic rheological tests the elastic modulus (G′), the viscous modulus (G″), and tan δ=(G′/G″ where δ is the phase angle) were obtained (Rao, 1992). Three types of dynamic tests can be conducted to obtain useful properties of gels and gel formation: a) Frequency sweep tests in which G′ and G″ are determined as a function of frequency at fixed temperatures. (b) Temperature sweep tests in which G′ and G″ are determined as a function of temperature at fixed ω. (3) Time sweep tests in which G′ and G″ are determined as a function of time at fixed ω and temperature (Rao and Steffe, 1992). FIG. 3 illustrates the time sweep test carried out on the mixture of soy protein and milk protein,

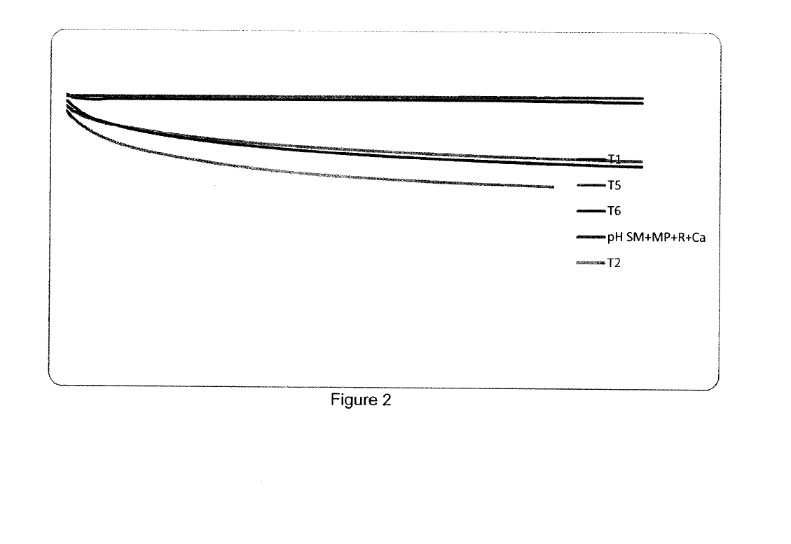

When soy protein and milk protein were combined together, after acidification the mixes showed a faster onset of gelation than control samples containing only casein micelles (FIG. 3). Moreover, when rennet was added into the mixes, it greatly affected the G′ value. Compare T5 to T6. This suggests that GdL was a prerequisite for onset of the gelation of the mixes (FIG. 2), and that renneting is needed to increase gel firmness, and to make sure caseins contribute to the gel network.

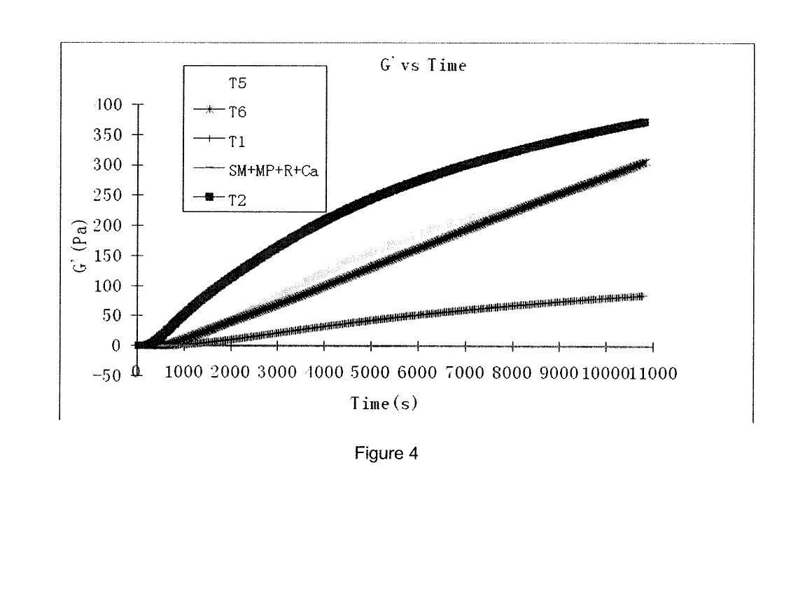

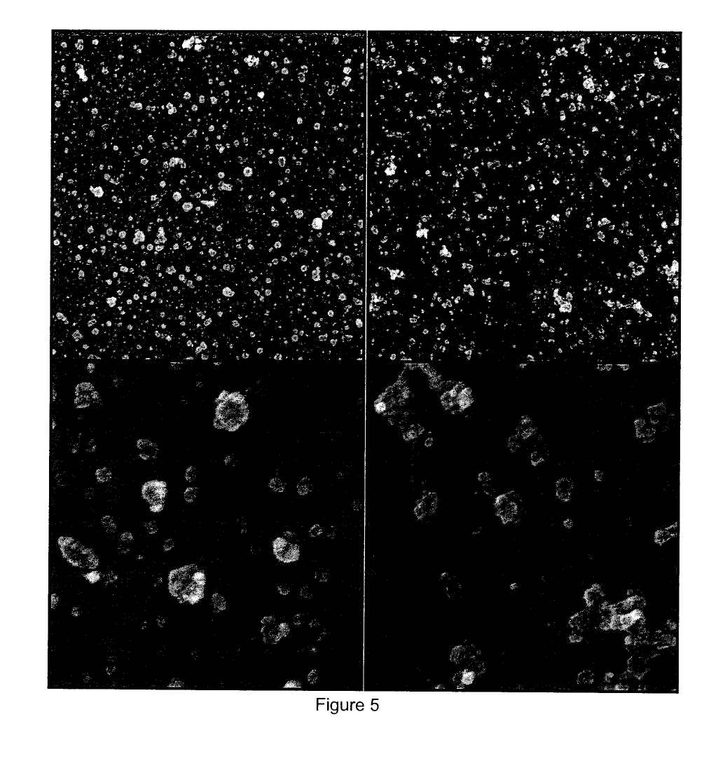

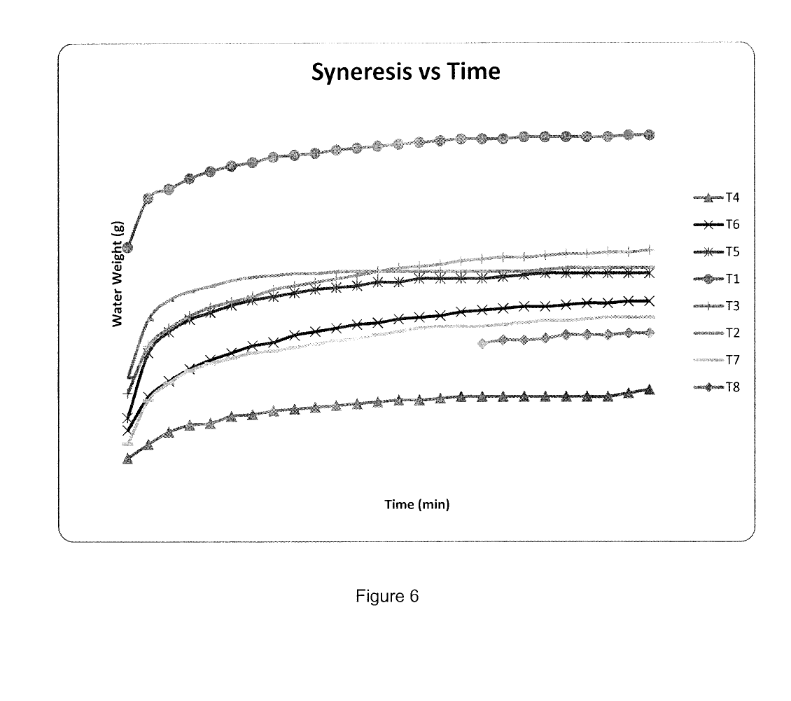

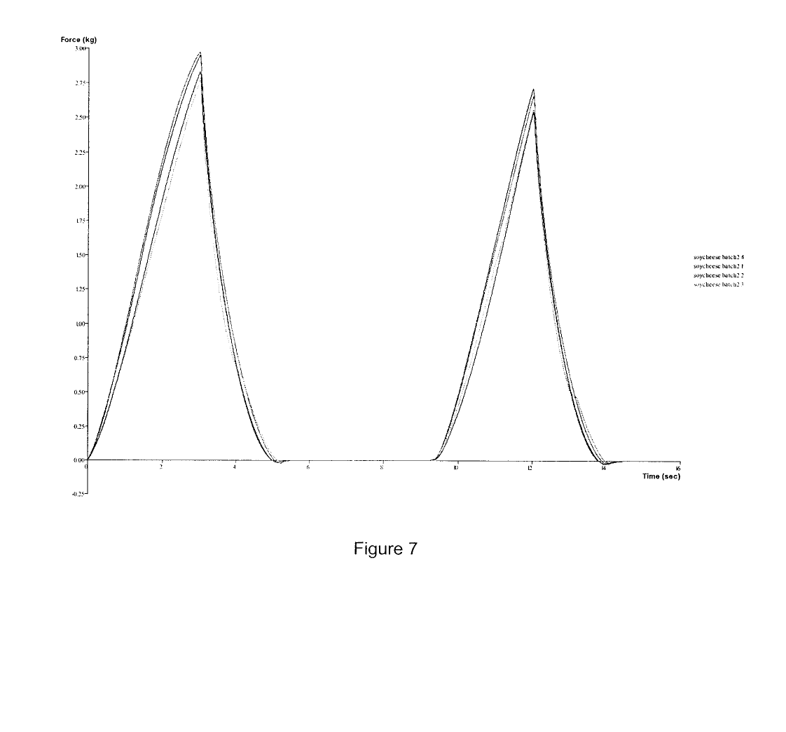

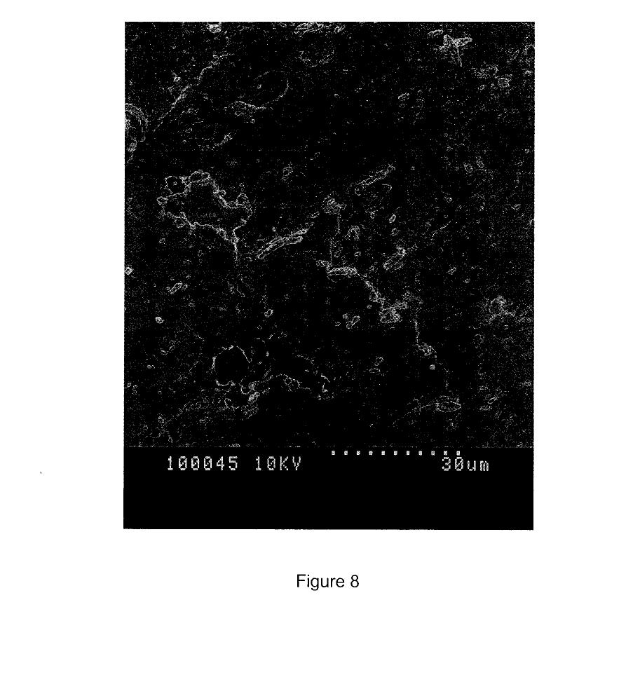

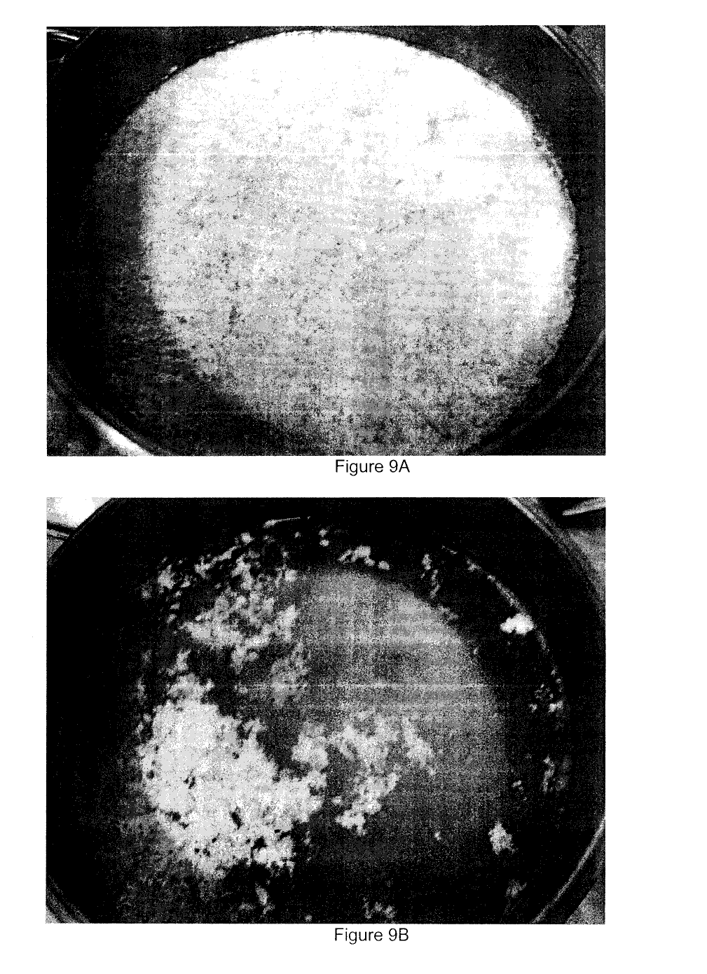

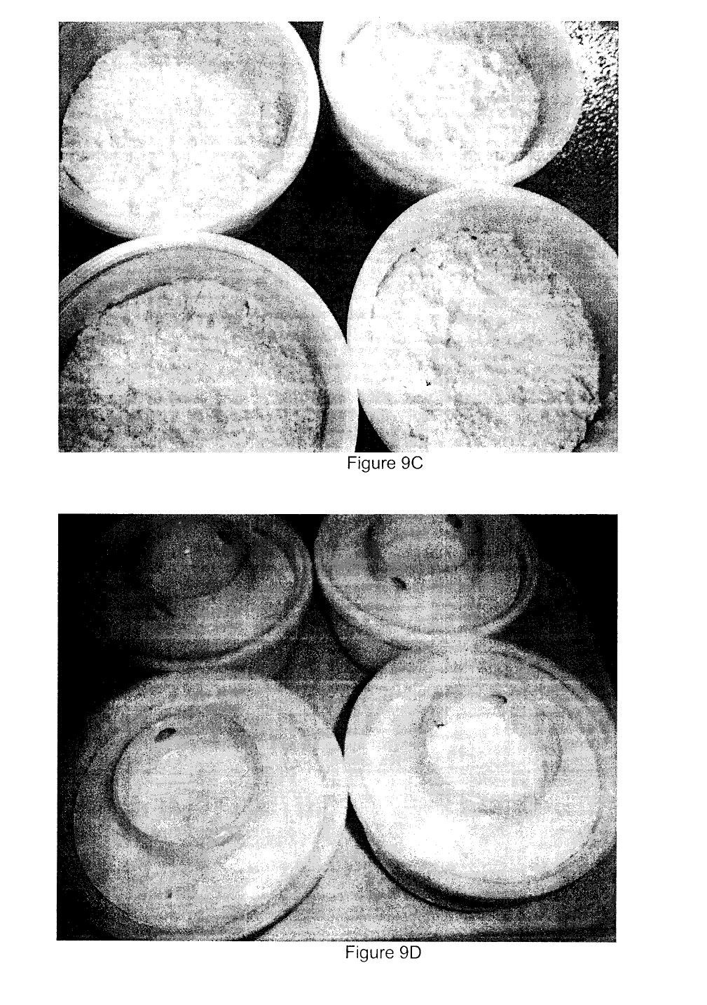

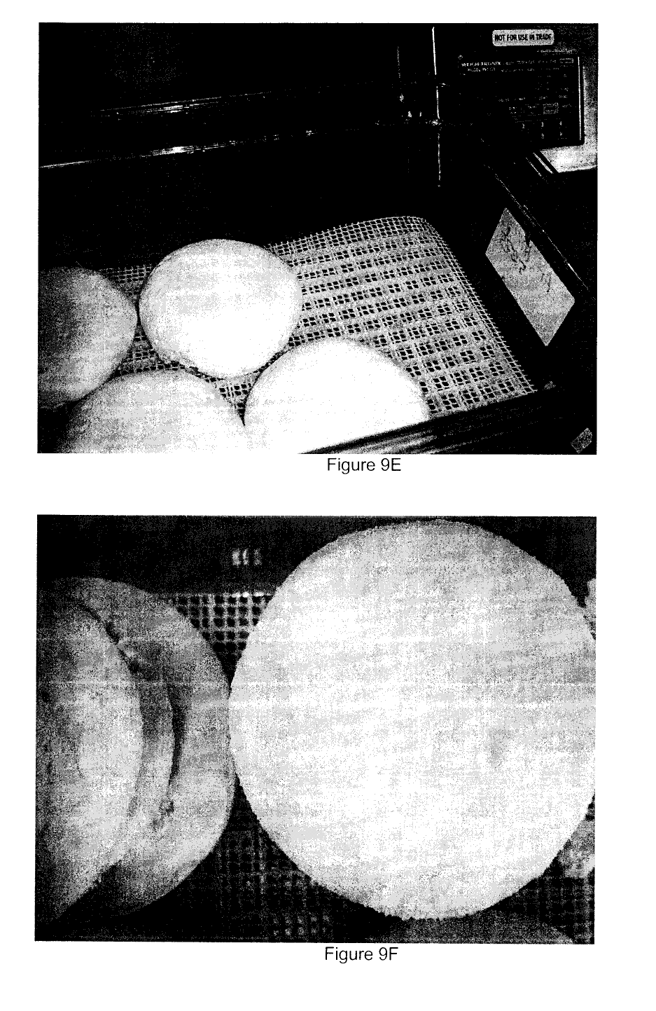

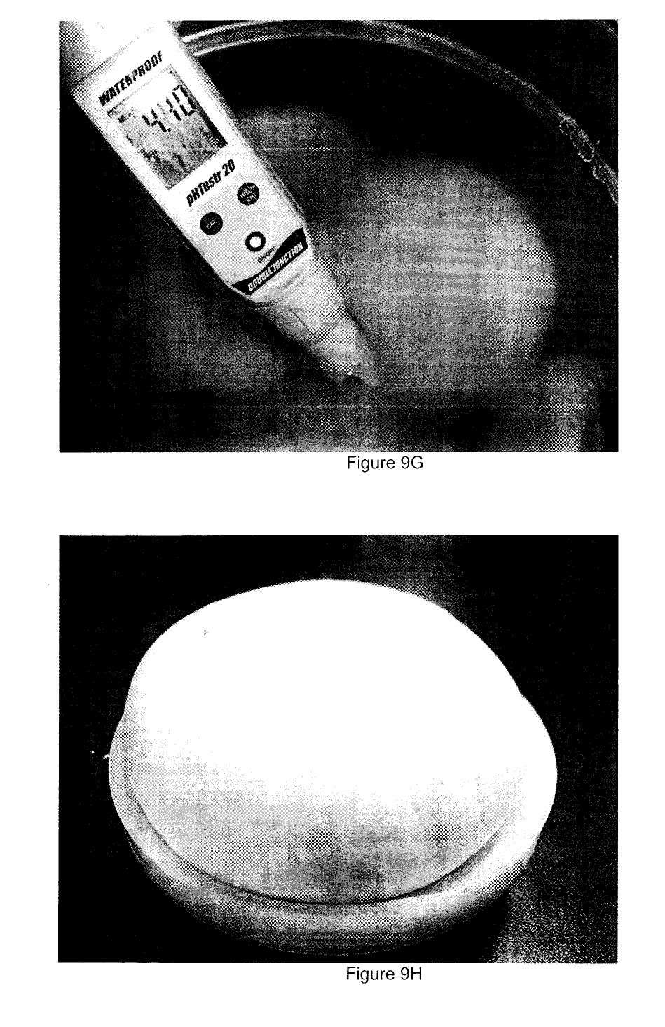

FIG. 4 depicts the development of the elastic modulus (G′) at 30° C. versus time for different mixtures treated by GdL and rennet as well as the corresponding control samples. The G′ used in the discussion refers to the final G′ achieved after 11000 s of incubation, and gelation time was reported as the time at which G′>1 Pa. The G′ versus time curves of T5 is different from T6 and the others. That means gelation was affected by the presence of rennet. But the mixes of SM/SMP (50/50) did not gel during rennet in the absence of GdL, possibly because the presence of soy protein disrupted the gelation of milk protein. Compared to T5, T6 and T2, T1 had less G′, which means that soy protein can form stronger gels than milk protein. Statistical analysis demonstrated that the final G′ value of the SM/SMP mixtures with addition of rennet was significantly different from that of the mixtures without rennet. In particular, note that the soy-milk mixtures gelled with GdL+Rennet (T5) had a greater final G′ (firmer gel) at 4000 s than the same mixture gelled with only GdL (Treatment 6). This suggests that renneted caseins are contributing to the structure of mixed gels more than non-renneted caseins. This was confirmed by confocal microscopy.

Confocal scanning laser microscopy: Confocal scanning laser microscopy (CSLM) measurements of soymilk, skim milk, and soymilk/skim milk mixture gels were performed on a Leica TCS SP Confocal Scanning Light Microscope (Leica, Heidelberg, Germany), in single photon mode, configured with an inverted microscope (model Leica DM IRBE), and using an Ar/Kr laser. Slices of approximately 0.2-0.5 cm thick were cut from the cylindrical shaped gels and the protein was labeled with two drops of a 0.1% aqueous solution of fluorescein isothiocyanate (FITC). The labeled slices were incubated at ambient temperature for 30 min to allow the dye to diffuse uniformly throughout the sample volume before direct microscopic observation. The light wavelength used to visualize the dye labeled sample was 488 nm. The emission maximum of the dye was 518 nm. The following Leica objective lenses were used: 20×/0.7NA/dry/HC PL APO, 63×/UV/1.25NA/water immersion/PL APO. In addition to 2D images, 3D image stacks were recorded and presented in 2D projections of the sample volume.

In a confocal laser scanning microscope (CLSM) a beam of light is focused on a small portion of the specimen, and a confocal point detector is used to recollect the signal from the sample. In-focus plane images are obtained and the out-of-focus regions appear as black background (Brakenhoff et al., 1988). It is possible to distinguish the spatial distribution of the components present in a sample by using fluorescent labeling dyes, such as FITC or rodamine B for protein, Bodipy or Nile red for lipids, and conjugates of lectins for polysaccharides. Confocal microscopy has several advantages: it can work in two modes (fluorescence and reflectance), it has the ability to scan samples at different depths; it is possible to obtain 3-D images without damage to the sample, high resolution images can be obtained, and it does not require major sample preparation (Vodovotz, 1996). Confocal microscopy is useful tool in the study of physical aggregation and phase separation, and to identify, albeit at times qualitatively effects of processing conditions and ingredient variation on the microstructure of gel with much less sample manipulation, at least compared to other conventional microscopy measurements (Vodovotz, 1996).

Confocal images in FIG. 5 show that SM coagulated with GdL (T1) forms larger strands than rennet coagulated SMP (T2). FIG. 5 also shows that increased protein concentration creates larger pores in soy gels formed with GdL and smaller pores in renneted skim milk proteins. FIG. 5 clearly shows that soy-dairy mixtures gelled with rennet and GdL have a much finer network structure (smaller pores) than mixed gels formed with only GdL. The network formed by the mixes with rennet during acidification (see T5 in FIG. 5) contained smaller pores, larger aggregates and denser clusters of protein than that of mixed gels without rennet during acidification (see T6 in FIG. 5).

SEM images (not shown here) confirm that the protein strands forming the gel structure in mixed gels formed with both GdL and rennet are thicker and appear more dense than in mixed gels formed with only rennet, suggesting that renneted caseins and soy proteins are interacting to form mixed strands of protein, which further interact to form the gel structure. In other words, two distinct types of gels can be formed with soy-dairy protein blends with a final pH in the range of 5.2-5.4 (note this is the pH of many rennet coagulated cheese varieties). First, using only GdL a gel based mainly on acid coagulated soy proteins is formed. In this case, the caseins apparently contribute little to gel structure. Second, using both GdL and rennet a gel is formed where rennet destabilized caseins interact with acid destabilized soy proteins and actively participate in gel formation.

Syneresis tests on the formed gels: Mixes were incubated in water baths at 30° C. for 1 h, and then the gel formed was placed on a plastic net and drained onto a balance to measure the amount of whey released over time. The whole system was placed into an environmental chamber at 0˜4° C. in order to control evaporation. The water weight excluded from the gel measured by the balance was recorded.

Factors such as pH, ionic strength, protein concentration, and temperature history and time influence the microstructure of protein gels (Kinsella 1982; Offer and Trinick 1983; Schnepf 1989; Hermansson 1986 and 1994; Damodaran 1996). During gelation a 3-dimensional network stabilizes water physically and chemically within the gel structure. So, protein-protein interactions are necessary to form the gel and stabilize water. However, stronger protein-protein interactions can also lead to thicker protein strands and larger pores in which the water is less firmly held and more easily pressed out. A more open structure with larger water pores has lower water holding capacity than a dense network structure (Stanley and Yada 1992). A gel will develop a dense network structure if protein-protein interaction is uniform throughout the gel network (Hermansson 1986, 1988; Niwa 1986). The extent of syneresis (water released from the gel) due to temperature changes or physical disruption of the gel can be predicted from the gel structure such as the size of water pores and the integrity of the gel network. Syneresis is desirable or undesirable depending on the further processing and the desired type of final product. For example, in a soy-dairy yoghurt type product, high water holding capacity is desirable. This would decrease the amount of stabilizers needed. However, if desired to make cheese like products, syneresis is desirable, as some whey needs to be released before the curd is manipulated.

FIG. 7 shows syneresis of soy, milk and mixed soy/milk gels. Treatment codes are defined in Table 1. Mixes including coagulants were incubated at 30° C. for 60 min. The resulting gels were placed on a plastic net at 4° C. and the whey released was weighed at 10 min intervals for 3 hours. Note results are not normalized for protein concentration, so treatments T1 and T2 which contain only 2% protein are valid comparators for each other, but not for the other treatments which contain 4% protein. Note also that there is missing data for T8; however, the available data confirms the trend that illustrated by T5, T6, T7 and T8 that syneresis of mixed soy-dairy gels improves with increasing amounts of renneted casein.

These observations suggest that the mixed gels with both GdL and rennet may hold more water than mixed gels with GdL because they have smaller pore sizes and apparently stronger strands forming the gel matrix. Preliminary results suggest the opposite is true. Note that although soy gels are much firmer than rennet SMP gels, rennet gels had much greater syneresis. This is seen when comparing T2 versus T1 and T4 versus T3 in FIG. 4. In mixed gels, renneted caseins improved the rate and extent of syneresis relative to mixed gels formed with GDL only. Higher amounts of soy protein relative to skim milk proteins in the mixes reduced the amount of syneresis (compare T5, T6, T7 and T8). Note that the syneresis versus time curve for the 50:50 soy-dairy mixture coagulated with GDL and rennet (T5, total protein 4%) is almost identical to the syneresis curve for renneted SMP (T3, protein 4%).

### Example Two

### Preparation and Characterization of Soy/Milk Cheese-Type Product (Curd)

Food grade soybeans were obtained from a local grocery store (30 kg bags). Pasteurized skim milk was obtained from a local supplier (Crown's Dairy, Agropur division) and stored in fridge (±4° C.). Rennet (125 μl) concentrated Chy-max Extra rennet (Chr. Hansen. Inc., Milwaukee, Wis., U.S.A) was diluted in 10 ml ultrapure water, and then added into 5 kg skim milk at 4° C. The milk containing rennet was stored in fridge overnight. The concentration of rennet was 0.020 IMCU/g. A freeze-dried concentrated lactic cheese culture (Choozit MA 16 LYO, Danisco, France) was used. The dosage was 0.625 DCU (0.005%) bacteria per 10 kg milk.

Soy/Milk Cheese-Type Product making and Storage of the Curd:

2 kg dry soybeans were soaked in 5 kg of deionized water overnight at room temperature, drained and rinsed once with water. The weight of soaked soybeans was 4.75 kg. Additional water (11.25 kg) was added to the soaked soybeans, and the mixture was processed with a Stephan Microcut MC-15 (Hameln, Germany) using 0.05 mm cutting ring for 4 times. The soybean slurry was filtered using a 5-speed juice extractor (Breville Ikon, Australia) at speed 3. The okara (filtered fiber material) was collected and passed through the juice extractor again. Soymilk is filtered through cloth fabric to remove fines, and heated to 95° C. with stirring in jacketed pot. The temperature was held for 5 min.

The milk was stored overnight with rennet added, so that the rennet would act on the proteins, without coagulation. The culture was then added into cold renneted milk and mixed for 2 min. At this point, the milk and soymilk were mixed together. The hot soymilk at about 85° C. was added into cold milk at about 6° C., and the mixture temperature reached very quickly 38° C. To aid in the gelation of soy protein, MgCl₂ (0.25 g/ml) was added as slowly as possible while manually stirring, and the coagulated mixture was left undisturbed to set for 30 min. The curd obtained was poured into cheese molds and incubated at 30° C. overnight. The next day, dry salt (3% of the total wet weight) was added to the curd, by rubbing it on all sides of the curd surface. The cheese was placed in plastic tubs with the lids partially open to allow some drying off of the cheese, and stored in fridge for two days. There was no pressure applied to the molds and the curd was turned a few times. After 2 days, the salted cheese was immersed into a brine composed of 8% salt, 0.5% CaCl₂, and 0.9% vinegar, pH=4.6, and stored at 4° C.

Characterization of the soy/milk cheese curd, chemical analysis, texture and microstructure: The pH of cheese was determined using a portable digital pH meter (pHTestr.20, Eutech Instruments) by inserting the probe into a block of cheese and penetrating to a depth of 2 cm. The protein content in soymilk, milk and soy cheese was measured by Dumas method using Nitrogen Analyzer (LECO, FP-528, Mississauga, On, Canada). About 0.2 g ground cheese samples was collected from the centre of cheese. Protein values of soymilk were calculated by multiplying the nitrogen content by 6.25, and for milk by 6.38 (for the cheese, 6.25). Total solids were estimated using the vacuum oven drying method. About 3 g of ground curd or cheese was placed into aluminum tins, and dried with vacuum oven at 50° C. for 18 h. After cooling for 30 min in a desiccator at room temperature, the weight was recorded.

As skim milk was used for the preparation, fat content was not measured. The textural properties of the cheese-product were measured using a TA.XT2 Texture Analyzer (Texture Technologies Corp., UK, Model TA.XT2, version 05.16) of Stable micro System equipped with a cylindrical probe (25 mm in diameter) with a 5 kg load cell. A texture profile analysis was carried out, using a pre-test Speed of 2.0 mm/s, a test speed of 2.0 mm/s, a post-test speed: 2.0 mm/s and a distance of 6 mm. The time was 3 s and the data acquisition rate: 200 pps.

The Texture Analyzer was calibrated before testing. The test protocol was summarized as follows: texture analysis is carried out at ambient temperature on cylindrical cheese blocks with 125 mm in diameter and 30 mm in height, immediately after removal from refrigerator at 4° C. Samples are compressed axially in two consecutive cycles without yield, with 20% deformation (6 mm) from the initial sample's height. Each sample was analyzed three times. Mean and standard deviations were reported.

Microstructural analysis was carried out by preparing 3 mm³ cheese samples, taken from with the cheese block, and mounted vertically on each of the copper holders designed for the Emitech 1250X cryo-preparation unit (Ashford, Kent, UK). Tissue-Tek®, a cryo-mounting gel, was used to ensure that the samples were affixed to the holder. The copper holders were plunged into liquid nitrogen slush (−207° C.) which was prepared by pulling a vacuum on the liquid nitrogen. Liquid nitrogen slush provides a faster freezing rate to minimize ice crystals which result in less distortion of the sample. The copper holders are withdrawn from the freezing chamber through argon to prevent frost forming on the surface of the samples. Samples are transferred frozen and under vacuum into the preparation chamber of the cryo unit where the frozen cheese is fractured. Samples were fractured by pre-cooled razor blade, thus provided a better surface for sublimation. Samples were sublimated for 1 hour at −80° C. After sublimation completed, samples were coated with 30 nm of gold. The thin coat of the high atomic number element provides conductivity to prevent the sample from absorbing the electron beam and also results in more secondary electrons being created, which are the primary signal for SEM imaging. Samples were transferred, frozen and under vacuum, into the SEM (Hitachi S-570) cryo-stage for observation at 10 KV accelerating voltage. The images were captured digitally using Quartz PCI imaging software (Quartz Imaging Corp. Vancouver, BC).

Soy/Milk Cheese-Type Product Composition:

TABLE 2
Compositional and physicochemical properties of soy/milk cheese.

| Composition/property | Soy cheese |
|---|---|
| Protein (%) | 16.0 |
| Total solid (%) | 30.2 |
| Fat (%) | Less than 1% |
| pH | 4.4 |

### Texture Analysis:

Hardness is the peak force of the first curve.
Springiness is a ratio of the two peak force.
Cohesiveness is a ratio of the total areas under the two curves.
Chewiness is the product of Hardness*Cohesiveness*Springiness.

| | | Co-efficiency of variation |
|---|---|---|
| | Force | (%) |
| Hardness | 2.88 kg | 3.7 |
| Springiness | 90.8% | 1.7 |
| Cohesiveness | 83.3% | 0.4 |
| Chewiness | 2.18 kg | 2.6 |

### Example Three

### Generation of Mixed Soy-Dairy Gels Using Soy Milk and making of Yoghurt

Dairy yogurt consumption has been steadily increasing over the years as consumers are increasingly searching for new healthy snack options with high protein and low fat contents. Thus it is now possible to generate novel yogurt products. Such yogurts deliver the health benefits of both dairy products (high calcium content, high protein quality and soy products (isoflavones) with high protein quality. In addition to the individual benefits of dairy and soy, the addition of skim milk powder to soy yoghurts enhances isoflavone glycoside transformation to a biologically active form during yogurt storage. Dual gelation as herein described allows for selective gelation of the proteins for improved understanding of the participation or interference of soy and milk proteins during mixed gelation.
Soymilk preparation. Soymilk (5% soy protein) was prepared according to the procedure of Malaki Nik, et al., {{88 Malaki Nik, A. 2010}} with slight modifications. In brief, Harovinton soybeans were soaked overnight in milli Q water for hydration. The hydrated soybeans were blended (Osterizer BLSTMG-WOO-033, Oster®) with a measured amount of water at room temperature (calculated to obtain the desired protein content) before being passed through a kitchen juicer (Professional Series 211, The Juiceman®) to further liquefy the sample. The soymilk was then passed through a cheesecloth to remove the okara (mainly composed of insoluble fibre material) and heated at 95° C. for 7 minutes before cooling it in ice and storing in a refrigerator at 4° C. until use. The soymilk was then used as is, without further centrifugation. Soy serum was prepared by first removing large particles by centrifugation (Optima™ LE-80K, Beckman Coulter) of the soymilk for 30 min at 20° C. and at 7980 g. Next, the soymilk was transferred to Macrosep Centrifugal Devices (10 kDa molecular weight cut-off) from Pall Corporation and centrifuged for two hours at 5000 g and 10° C. Following centrifugation, soy serum was poured out from the filtrate receivers and kept in the refrigerator (4° C.) until further use, within 5 days.
Skim milk preparation. Fresh milk was collected from the Elora dairy research station of the University of Guelph. Sodium azide was added at a concentration of 0.02% (w/v) to prevent bacterial growth. Milk was centrifuged at 6000 g for 20 min at 4° C. using a Beckman J2-21 centrifuge and JA-10 rotor (Beckman Coulter, Mississauga, ON, Canada). Milk was then filtered four times through Whatman glass fiber filters (Fisher Scientific, Whitby, ON, Canada) before being subjected to ultrafiltration (PLGC 10 k regenerated cellulose cartridge, Millipore Corp., Bedford, Mass.). During ultrafiltration, both the milk permeate (devoid of protein) and the retentate (concentrated milk containing all the proteins) were collected. Ultrafiltration was continued until a protein concentration of 4% was reached, as determined by the volume of permeate removed. The skim milk was stored in the refrigerator at 4° C. until use.
Protein determination. Protein contents of skim milk and soymilk were analyzed using the DC protein assay kit (B10 RAD).
Soy milk characterization. Mineral content of soymilk serum was determined using atomic absorption spectroscopy and the serum was found to contain the following: 80 μg calcium, 190 μg magnesium, 200 μg phosphorus, 1400 μg potassium, <95 μg sodium and 83 μg sulfur.
Gel preparation. Samples were generated by mixing equal volumes of unheated concentrated skim milk (SM, 4% protein) and soymilk (SOY, 5% protein) resulting in a total protein concentration of 4.5%. Calcium chloride (Fisher Scientific, Whitby, ON, Canada) was added to all samples at a concentration of 1 mM as reported by Li et al {{89 Li, Jie 2006}}. Glucono-delta-lactone (GDL) (Sigma-Aldrich Co., St. Louis, Mo., USA) was added at 0.6% at 30° C. to slowly reduce the pH from ˜6.6 to ˜5.5 over the course of the 3 hour experiments. Rennet (Chymax Ultra Rennet (790 IMCU/mL), Chr. Hansen, Milwaukee, Wis., USA) was added in concentrations of 0.1074 IMCU/mL (high rennet) as well as 0.0537 IMCU/mL (low rennet) at 30° C. It was anticipated that the interpretation of binary gelation of a mixed system would be very challenging considering the lack of information available and the possible synergistic/competitive effects. Thus, a large number of controls were deemed essential to provide a better understanding of the gelation behaviour of the mixed system. Controls included the mixed system with each of the gelling conditions alone (high rennet alone, low rennet alone or GDL alone). Additionally, every combination of the gelling agents (Table 1) was applied to 4% skim milk, 2% skim milk (diluted 1:1 with soy serum), 5% soymilk and 2.5% soymilk (diluted 1:1 with milk permeate). Gelation experiments were repeated in triplicate if they gelled and in duplicate if they did not gel.

### Gelation Studies

Each sample for rheology and DWS was prepared in volumes of 35 mL and distributed as follows: 1.5 mL for light scattering experiment, 20 mL for rheology and the remaining amount was used for pH measurement. Rheology, light scattering and pH measurement were carried out simultaneously.
Diffusing Wave Spectroscopy. Diffusing wave spectroscopy (DWS) was employed to measure the temporal fluctuations of light that have been scattered by a system, without the deleterious effect of dilution and in a steady (undisturbed) state. It is based on the measurement of temporal fluctuations of light due to the (Brownian) motion of its scatterers. By careful interpretation of the signal, it can yield information on the dynamic properties of the colloidal system via the diffusion coefficient, which can then be used to calculate the hydrodynamic particle radius with the Stokes-Einstein relation. A more detailed description of DWS theory is found elsewhere {{103 Weitz, D. 1993}}. The light source was a solid diode pumped Nd:YAG laser emitting light with a wavelength of 532 nm and a power of 350 mW. For a detailed set-up of the experiment please refer to Alexander et al. {{100 Alexander, Marcela 2004}}. All samples except the 2% skim milk were placed into a 5 mm, 1.5 mL glass cuvette and measured at 30° C. controlled by an external water bath. The 2% skim milk samples were analyzed in a 10 mm (3 mL) glass cuvette to ensure sufficient multiple scattering. Each treatment was measured in triplicate (i.e., three separate milk or soymilk batches) and analysis was carried out until gelation. In all cases, the light scattering measurements were collected for 2 minutes with intervals of 1 second. Data was analyzed using DWS-Fit software (Mediavention Engineering Inc., Guelph, ON, Canada) and Sigma Plot 10.0 (SPSS Inc., Chicago, Ill., USA). The gel point was extrapolated from the plot of increase in radius as a function of pH/time.
Rheology. Experiments were carried out using a controlled stress rheometer at a constant strain of 0.01, a frequency of 0.1 Hz and an initial stress of 6 mPa. The temperature was controlled with an external water bath and kept at 30° C. Rheological measurements were carried out in triplicate and each experiment was continued for 3 hours. Rheology was not performed on 2% skim milk samples due to the difficulty in obtaining large volumes of soy serum. The gel point was taken as the pH/time at tan δ=1.
pH Measurement. Samples were kept at 30° C. in a circulating waterbath during pH measurements. pH measurements were recorded every 11 s into an excel spreadsheet automatically by AR15 pH recorder software (Mediavention Engineering Inc.) during the course of the 3 hour experiments.
Confocal microscopy of final gels. 20 μL of Rhodamine B (0.2% w/v in milliQ water) was added to 5 mL of sample for staining. Two drops of sample were placed into grooves of a concave microscope slide and a cover slip was placed overtop and sealed. Slides were incubated at 30° C. for three hours before analysis. Images were taken using an inverted confocal laser scanning microscope (Leica TCS SP2, model Leica DM IRE2, Leica Microsystems CMS GmbH, Mannheim, Germany) with an Ar/Kr visible light laser, 63x (oil) objective. Experiments were repeated in triplicate.

### Gelation Behaviour

Mixtures of soymilk (5% protein) and concentrated dairy milk (4% protein) were prepared in a 1:1 ratio and analyzed by DWS and rheology to investigate the sol-gel transition times and subsequent formation of the gels. While DWS looks at changes and rearrangements happening at the microstructural level, rheology detects the macro-characteristics of a sample. By combining both techniques, along with microscopy, a more complete picture of the gelling behaviour of the samples could be obtained.

All samples were supplemented with 0.1 mM CaCl₂ to compensate for the lower calcium content of soymilk as it is known that casein micelles dissociate at low levels of calcium. As mentioned earlier, soy proteins have a higher isoelectric point than milk proteins. Thus, if only acidification is used, soy proteins will aggregate far earlier than milk proteins. For this reason, rennet was added to induce aggregation of casein proteins closer to the gel point of soy proteins. Gelation was induced by addition of 0.6% GDL and two concentrations of rennet. The relatively low concentration of GDL resulted in a gradual decrease in the pH of the sample allowing for more careful observation of the early stages of gelation. Two concentrations of rennet were used (high and low) to examine the effect of modulating the timing of casein aggregation. To distinguish between the activity of rennet and acid, control experiments were conducted wherein GDL and rennet (at both concentrations) were added to the system in isolation.

In addition to observing the activity of each gelation mechanism in isolation, it was also important to observe the behaviour of each protein source in isolation. Thus additional control experiments were conducted to observe gelation of soymilk and skim milk alone to determine the contribution of each protein source to the gelation behaviour in the mixed system. The actual concentration of soymilk and milk proteins in the mixed system was 2.5 and 2%, respectively. However these individual low protein concentration systems do not accurately represent the actual conditions of the mixed system where the total protein content is higher and proteins are in closer proximity to each other. Thus, all of the controls were measured at high protein concentrations (4% protein skim milk and 5% protein soymilk) and low protein concentrations (2% protein skim milk and 2.5% protein soymilk), reflecting the actual amount of soy and dairy proteins in the mixed system. Control experiments for addition of rennet only (no acidification) to either skim milk or soymilk in isolation were done and the results show an initial casein micelle size of approximately 120 nm radius. As the time after rennet addition progressed, the size of the micelles decreased slightly as the k-casein was cleaved by the action of chymosin. Eventually, the casein micelles were destabilized and coagulation took place. This is perceived as an increase in the radius measured by DWS, changing from about 120 nm to over 3 microns in the span of 10 minutes. Similarly, when the gelation behaviour was followed by rheology the elastic modulus, G′, remained low and constant during the initial minutes until the gel point, at which the G′ increased rapidly. There was a noticeable difference in coagulation point for the skim milk renneted with the low rennet concentration (˜29 min) and high rennet concentration (˜18 min) as more enzyme resulted in a higher rate of cleavage taking place. Gelation points were measured by DWS and rheology for all the systems were investigated in this study. There was a slight difference in coagulation time between DWS and rheology. This has been observed before and it is due to the different length scales probed by the two techniques {{98 Holland, Ben 2011}}. While DWS looks at the movement of individual colloids, rheology can only measure the combined and cooperative effect of the colloids in the system. The final G′, 180 minutes after rennet addition was approximately 185 Pa for both the high rennet and low rennet samples.

Overall, the results suggest that if rennet were added to a mixed soymilk-dairy milk sample, only the dairy component would be affected by the action of rennet. Control experiments for addition of only GDL (no renneting) to either skim milk or soymilk in isolation were completed. There was an initial period of invariance in size, until the pH was progressively lowered to near the isoelectric point of soy proteins. At this point, there was sufficient neutralization of surface charges on soy proteins to allow them to approach each other and begin to aggregate, as expressed by the sudden increase in radius. The gelation pH for the low and high protein samples was around 6.0 and 5.9, respectively. Although the gel points are statistically different, in reality a pH difference of 0.1 would not be considered important. Although the 2.5% and 5% soymilk controls gelled at a similar pH, rheological measurements revealed that the final G′ of the 5% soymilk (˜130 Pa) was around five time higher than that of the 2.5% soymilk (˜25 Pa). This result should be expected as the higher concentration of protein allows for a higher number of bonds to be created between particles, thereby increasing the stiffness of the gel.

When only rennet was added to the mixed system, this sample did not result in any increase in radius during the three hours of observation (figure not shown). It is known from control experiments that soy proteins were not affected by rennet addition. Thus only milk proteins could have been acted upon in this instance. However, the mixed system contained 2% skim milk proteins which, as mentioned before revealed that there was likely insufficient number of milk proteins available to build the gel network. Furthermore, the scattering signal arising from the milk protein component was also mostly overshadowed by the soymilk scattering in DWS.

GDL was observed alone on the mixed soymilk-dairy milk system. From the control samples it is known that skim milk proteins did not aggregate at these levels of GDL and only soy proteins were affected. DWS from this acidified mixed system show the initial radius of this sample was similar to that of soymilk particles alone, around 500 nm. As the pH dropped to pH 6.1, the size of the proteins remained constant. At pH 6.16, there was a clear increase in radius. This gelation point is slightly earlier than that shown by DWS on 2% soymilk alone. However, this discrepancy could be due to the method by which gelling point is calculated in DWS. The extrapolation of a straight line following the radius increase down to the x-axis was difficult to accomplish accurately at the shoulder. Nevertheless, the difference in gelation pH was minimal. The radius continued to increase down to pH 5.6 where there was a change of slope, and a drastic increase in radius. It is worthwhile to point out, that the kinetics of this acidified system, as shown by DWS, differed from that of the soymilk alone, as the shoulder seen in this mixed milk was not present when only soymilk proteins were aggregating. Interestingly, the rheological measurements showed gelation at pH 6.1, which was statistically equal to the gel point of soymilk alone in the control experiments and in agreement with that shown by the shoulder in DWS. It could be speculated that protein aggregation in this system, as shown by DWS, was manifested as the initial increase in radius at the beginning of the shoulder, but aggregation did not ensue rapidly because of interference from unaggregated milk proteins. Although soy proteins may have begun to aggregate around pH 6.1, rapid and full coagulation may not have taken place until the net charge of the soy proteins had been sufficiently neutralized to overcome the disturbances of the milk proteins, in this case around pH 5.6.

The reason why the rapid increase in radius only occurs at pH 5.6 may be explained by the reduction of net charge in soy particles due to the combined effect of a reduction in pH and calcium release from casein micelles. This would demonstrate a synergistic effect in gelation of the mixed system wherein calcium release from casein micelles accelerates gelation of soy proteins.

The desired system of interest is the mixed soy milk-dairy milk system with added GDL and rennet. DWS plots of the soymilk-skim milk mixture show a dual gelling system. Once more, the initial radius was measured to be around 500 nm which remained constant for the initial pHs. Regardless of whether the high or low rennet concentration was used in combination with GDL, the mixed soy-milk systems showed a drastic increase in radius and gelled around pH 6.0. As explained earlier, the agreement in gel point between samples with the low and high rennet concentrations can be attributed to the excess rennet in solution. From the control experiments, and under the conditions used in this experiment, acidifed soy proteins gelled at a pH 6.0 and 2% milk proteins at a pH of 6.1, however, these were not significantly different. Thus, it is clear that at the gelation point of the mixed system (which is also not significantly different from the control systems just mentioned) both milk and soy proteins participate in a mixed gel network when the system is acidified and renneted simultaneously. Thus, the presence of rennet was effective in making milk proteins available to aggregation and therefore enabled them to participate in network formation rather than to interfere with network formation.

Rheology data also shows the sol-gel transition around a pH of 6.1, in agreement with the DWS data. This gel point is slightly later than the systems with skim milk alone but slightly earlier than that of soymilk. It could be interpreted as a compromise between the two gelling forces. Although the pH of gelation of the mixed system was the same with high and low rennet, the elastic modulus (G′) indicates that the gel structures differed. The G′ with high rennet and acid was around 86 Pa whereas with the lower concentration of rennet it was not possible to obtain a consistent (final) G′. This suggests that, although the system contained excess rennet to fully cleave the k-casein in the micelles, a desired concentration of rennet may be required to generate a self-supporting gel structure in the mixed system, possibly due to competing elements or structure formation. Furthermore, if the elastic modulus of the mixed system was compared to the controls, it can be observed that even when both proteins participated in the gel network (4.5% total protein), the gel stiffness (˜86 Pa) was still far lower than that of 4% skim milk or 5% soymilk alone (˜190 Pa and 130 Pa, respectively). This might be further indication that there may be some antagonistic effects which impede gel stiffening in the mixed system.

### Microstructure

Confocal images show that the soymilk gel, produced with GDL, appears as densely packed aggregates of soy proteins. The milk gel, produced with GDL and high rennet, exhibited a very different structure: the milk gel had a network-like appearance with large pores and interconnecting strands. The mixed soymilk-skim milk gels had appearances which were in between, exhibiting a network of strands of aggregated protein. These images indicate that the mixed systems may have microstructures different from those of pure soy gels and pure milk gels. When confocal images of the mixed system with the different gelling agents were compared, no obvious differences were observed between the samples using imaging technology. In general, the structures were more open than those of soymilk alone but more closely packed than those of skim milk alone.

1. A soy/milk cheese-type product prepared by a method comprising:
(a) mixing hot soy milk with cold renneted milk;
(b) acidifying and adding a firming agent to said mixture from (a);
(c) mixing the product resulting from (b) for a time sufficient to cool (b) and effect simultaneous gelation of soy milk and milk;
(d) transfer the product resulting from (c) into molds at a temperature of less than about 35° C.; and
(e) optionally salting (d).

2. The product of claim 1, wherein said method further comprises subjecting the molded product from (d) to external pressure.

3. The product of claim 1, wherein said product is further brined.

4. The product of claim 1, wherein said milk is present in amounts of from about 10% to about 90%.

5. The product of claim 1, wherein said milk comprises 0% to 10% fat.

6. The product of claim 1, wherein said firming agent is calcium chloride.

7. The product of claim 6, wherein said firming agent is present in amounts from about 0% to about 0.5%.

8. The product of claim 1, wherein said milk is renneted using rennet or a synthetic rennet equivalent.

9. The product of claim 1, wherein acidification is effected by the addition of a lactic bacterial culture.

10. The product of claim 9, wherein said lactic bacterial culture is added to the cold renneted milk prior to step (b).

11. The product of claim 1, wherein acidification is effected by the addition of GdL, magnesium and/or calcium ions to (a).

12. A method for making a soy/milk cheese-type product, the method comprising:
(a) mixing heated soy milk with cold renneted milk;
(b) acidifying and cooling (a) to effect simultaneous gelation of the soy milk and the milk;
(c) coagulating cooled (b) and setting;
(d) allowing (c) to incubate overnight; and
(e) dry salting (d) to form said cheese-type product.

13. The method of claim 12, wherein the acidifying comprises adding lactic acid, citric acid, or GdL to (a).

14. The method of claim 12, wherein the acidifying comprises adding lactic acid-producing bacteria to the cold renneted milk prior to mixing with the heated soy milk.

15. (canceled)

16. (canceled)

17. (canceled)

18. (canceled)

19. A soy/milk cheese-type product or a soy/milk yoghurt-type product, said products comprising mixed gels of rennet coagulated casein micelles and acid coagulated soy protein.

20. The products of claim 19, wherein said coagulated soy protein is present as strands of interacting soy protein with said casein.

21. The products of claim 20, wherein the product is a soy/milk cheese-type product having hardness, springiness, cohesiveness and chewiness similar to milk only soft cheese.

22. The products of claim 20, wherein said product is a soy/milk yoghurt-type product with a high water holding capacity.

23. The products of claim 19, wherein said soy protein is present in an amount of about up to 60% of said product.

24. The products of claim 19, wherein said milk protein is present in an amount of about up to 90% of said product.

25. The products of claim 19, wherein said product further comprises one or more of nonfat dry milk, a milk protein, an acidity regulator, an acid, an anticaking agent, an antifoaming agent, a coloring agent, an emulsifier, an enzyme preparation, a flavoring agent, a firming agent, a food protein, a gelling agent, a preservative, sequestrants, a stabilizer, a starch, a thickener, an oil, a fat, a cheese powder, a salt, a nutritional supplement, an acid, an enzyme, a neutraceutical, a carbohydrate, a vitamin, a mineral, soluble fiber, fruit, vegetables, nuts, meat, spices, and other foodstuffs.

26. (canceled)

27. (canceled)

28. The soy/dairy yoghurt-type product of claim 19 having less degree of syneresis leading to high water holding capacity similar to yoghurt.

29. (canceled)

30. (canceled)

31. (canceled)
